(19) United States
(12) Patent Application Publication
(10) Pub. No.: US 2014/0142917 A1
(43) Pub. Date: May 22, 2014

(54) ROUTING OF MACHINE LANGUAGE TRANSLATION TO HUMAN LANGUAGE TRANSLATOR

(71) Applicant: Lindsay D'Penha, Salinas, CA (US)

(72) Inventor: Lindsay D'Penha, Salinas, CA (US)

(21) Appl. No.: 13/680,583

(22) Filed: Nov. 19, 2012

(51) Int. Cl. G06F 17/28

(52) U.S. Cl. CPC G06F 17/28
USPC 704/2

(57) ABSTRACT

A language translation system receives a request for a translation of a set of text from a first language to a second language. Further, the language translation system provides the request to a machine language translator. In addition, the machine language translator performs a machine translation of the set of text from the first language to the second language. The machine language translator determines that the machine translation should be modified by a human translator. Further, the machine translation is provided to the human translator for modification after the determination.

### BACKGROUND

1. Field

This disclosure generally relates to the field of language translation. More particularly, the disclosure relates to machine language translation and human language translation.

2. General Background

The language translation industry continues to grow with the increasing demand for language translation. Language translation provides assistance to a variety of fields. Language translation involves a set of text being translated from a first language to a second language.

Recent developments have led to machine language translation such that a customer may receive language translation from an automated system. Such machine language translation may help reduce the personnel costs of a language translation system provider. For example, the language translation system provider may avoid many of the costs of hiring, training, and employing human language translators. However, such machine language translation is still at the early stages of development. As a result, current machine language translation n systems may not be providing a satisfactory language translation experience for many customers.

### SUMMARY

In one aspect of the disclosure, a process is provided. The process receives, at a language translation system, a request for a translation of a set of text from a first language to a second language. Further, the process provides, at the language translation system, the request to a machine language translator. In addition, the process performs, with the machine language translator, a machine translation of the set of text from the first language to the second language. The process also determines, with the machine language translator, that the machine translation should be modified by a human translator. Further, the process provides the machine translation to the human translator for modification after the determination.

In another aspect of the disclosure, a computer program product is provided. The computer program product comprises a computer useable medium having a computer readable program. The computer readable program when executed on a computer causes the computer to receive, at a language translation system, a request for a translation of a set of text from a first language to a second language. Further, the computer readable program when executed on the computer causes the computer to provide, at the language translation system, the request to a machine language translator. In addition, the computer readable program when executed on the computer causes the computer to perform, with the machine language translator, a machine translation of the set of text from the first language to the second language. The computer readable program when executed on the computer also causes the computer to determine, with the machine language translator, that the machine translation should be modified by a human translator. Further, the computer readable program when executed on the computer causes the computer to provide the machine translation to the human translator for modification after the determination.

In another aspect of the disclosure, a system is provided. The system includes a reception module that receives, at a language translation system, a request for a translation of a set of text from a first language to a second language. Further, the system includes a routing module that provides, at the language translation system, the request to a machine language translator. In addition, the system includes a machine language translator that performs a machine translation of the set of text from the first language to the second language. The system also includes a processor that determines that the machine translation should be modified by a human translator. Further, the system includes a modification module that provides the machine translation to the human translator for modification after the determination.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a language translation system that may be utilized to provide a machine language translation service.

FIG. 2 illustrates a language translation system that may be utilized to route a machine language translation to a human translator.

FIG. 3 illustrates a configuration that may be utilized for text translation.

FIG. 4 illustrates a process that provides a transition from a machine language translator to a human language translator.

FIG. 5 illustrates a block diagram of a system that provides routing from machine language translation to human language translation.

### DETAILED DESCRIPTION

A method, computer program product, apparatus, and system are provided for a routing of a machine language translation to a human language translator. In one embodiment, a language translation system receives a request for a language translation. The request may be a real-time request or a delayed time request. An example of a real-time request may be a request for translation during a chat session. A plurality of users may be conversing with each other through a chat session on different computing devices. The users may be chatting in different languages. Accordingly, the request may be sent to an intermediary language translation system that translates text from a user or a plurality of users in real-time. An example of a delayed time request may a request for a translation of a document. For instance, a user may send a document in a first language to a language translation system with the expectation that the language translation system may take a significant amount of time to perform the translation. Accordingly, the user may send the document and not wait for an immediate translation.

Further, in one embodiment, the language translation system utilizes a machine language translator to perform the language translation. The machine language translator may determine that the machine language translation system is not accurate enough. As a result, the language translation system may route the machine language translation to a human translator for modification and/or further language translation. As an example, the machine language translator may translate the machine language translation from a first language into a second language. The machine language translator may then perform a subsequent machine language translation from the second language into the first language. Accordingly, the machine language translator may then perform a comparison between the machine language translation and the subsequent machine language translation to determine if the accuracy is within a predetermined threshold margin of error. In other words, the machine language translator utilizes its own logic to determine if the machine language translation should be routed to a human language translator. In an alternative embodiment, a processor that is distinct from the machine language translator may perform the comparison to determine the level of accuracy.

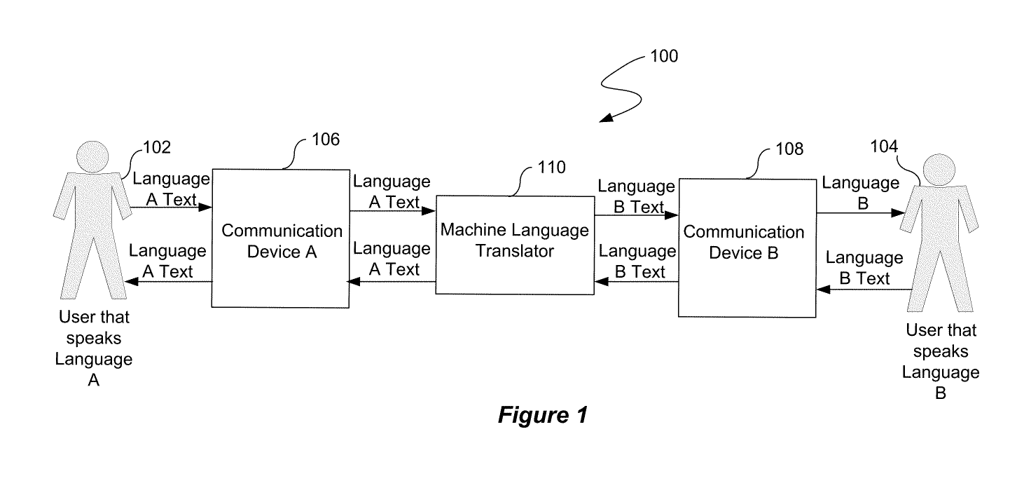

FIG. 1 illustrates a language translation system 100 that may be utilized to provide a machine language translation service. As an example, a user 102 that speaks language A may wish to converse with a user 104 that speaks language B. In one embodiment, the users may utilize communication devices. For example, the user 102 that speaks language A may utilize a communication device A 106. Further, as an example, the user 104 that speaks language B may utilize a communication device B 108. A communication device as provided for herein may be a telephone, smart phone, cell phone, tablet device, personal computer (“PC”), laptop, notebook, or the like. The users may utilize their respective communication devices to connect to a machine language translator 110. The users may connect through a network such as a public switch telephone network (“PSTN”), Internet, local area network (“LAN”), wide area network (“WAN”), Ethernet connection, wireless network, or the like. In one embodiment, the users transmit messages containing text to one another through their respective communication devices. Further, in one embodiment, the messages are inputted by the user through a keyboard interface. In an alternative embodiment, the messages are translated from voice input from the users to text for translation by the machine language translator.

The machine language translator 110 translates the text communication according to the desired language for the users. For example, the machine language translator 110 may translate the text communication from language A from the user 102 that speaks language A into language B for the user 104 that speaks language B. Further, the machine language translator 110 may translate the text communication from language B from the user 104 that speaks language B into language A for the user 102 that speaks language A. In one embodiment, the machine language translator 110 is automated. In other words, the machine language translator 110 may operate without manual intervention. For example, the machine language translator 110 may receive the text communications and automatically provide language translation for the text communications. The machine language translator 110 may be a hardware device. Alternatively, the machine language translator 110 may be a set of computer implemented instructions residing on a computing device. In yet another alternative, the machine language translator 110 is a combination of a hardware device and a set of computer implemented instructions residing on the hardware device. With any of the configurations provided for herein, a hardware processor may be utilized to implement the machine language translator 110.

An example of the language translation system 100 is a system that provides language translation for users inputting text for a chat session. Another example of the language translation system 100 is a system that translates text messages from users utilizing smartphones and speaking different languages.

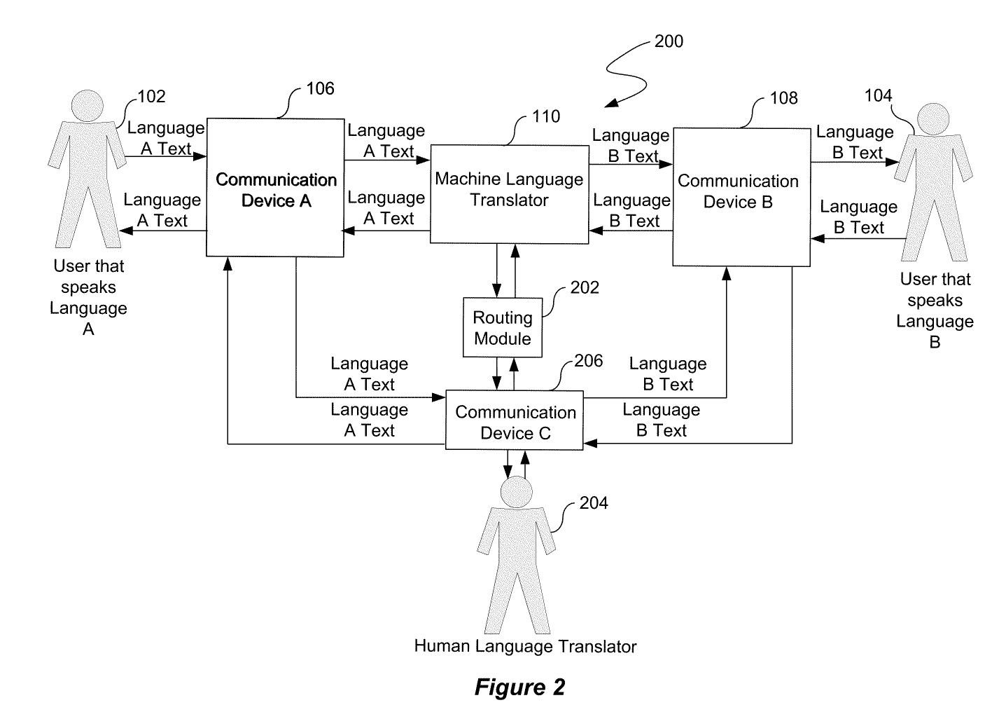

FIG. 2 illustrates a language translation system 200 that may be utilized to route a machine language translation to a human translator. As an example, a routing module 202 may be utilized to perform the routing. The routing module 202 may transition a text communication between the user 102 that speaks language A and the user 104 that speaks language B from the machine language translator 110 to a human language translator 204. In one embodiment, the human language translator 204 utilizes a communication device C 206 to provide the language translation for the text communication. In one embodiment, the human language translator 204 provides a real-time text translation. In another embodiment, the human language translator 204 provides a delayed time text translation.

Further, in one embodiment, the human language translator 204 utilizes the machine language translation. For example, the human language translator 204 may review the machine language translation and make modifications to that machine language translation. As a result, the human language translator 204 may improve his or her efficiency. For example, the human language translator 204 may quickly review the correct parts of the machine language translation and concentrate his or her efforts on the incorrect parts of the machine language translation. The human language translator 204 may then be able to review more translations than he or she would normally be translating. Accordingly, language translations services may utilize a combination of machine language translation and human language translators to improve efficiency and quality of language translation. Further, language translations services may reduce the number of human language translators that are utilized for language translation, which may result in labor cost reductions.

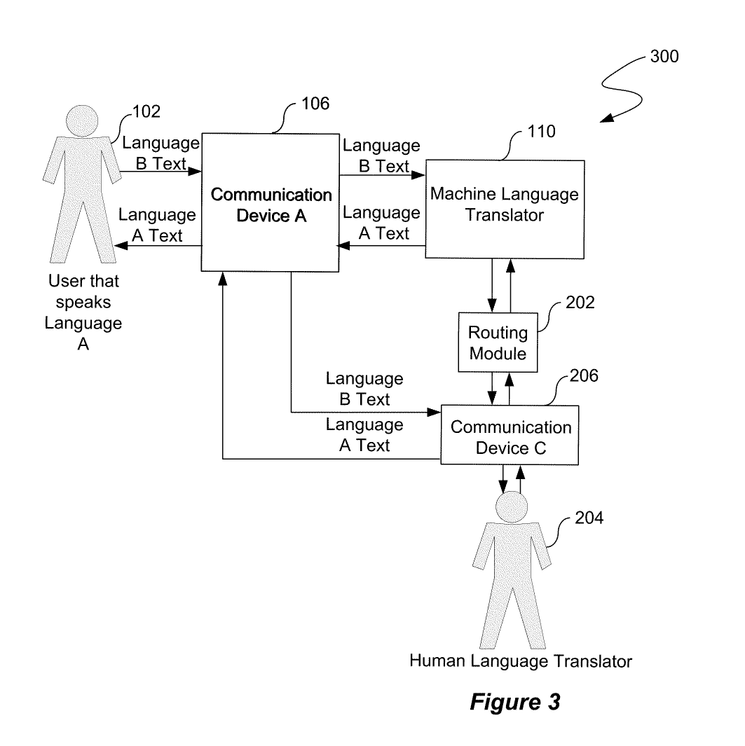

FIG. 3 illustrates a configuration 300 that may be utilized for text translation. As an example, a user may want to have a document translated rather than have a conversation with another user. For instance, the user that speaks language A 102 may have a document in language B. Accordingly, the user that speaks language A 102 may send the document in language B to the machine language translator for translation to the language A. The machine language translator 110 may perform a translation and determine that the translation is not accurate. Accordingly, the machine language translator 110 may send the machine language translation to the human language translator for modification and/or further translation.

Any of the configurations provided for herein may allow various determinations to be utilized to determine a routing of a machine language translation to a human language translator. For example, the machine language translator may monitor feedback from the users. For instance, if a user provides certain phrases to another user that may indicate an inaccurate translation, the machine language translator or processor may detect those phrases and route the machine language translation to a human language translator. Those phrases may be predetermined and stored in a database. For example, a phrase such as “don't understand” may indicate that the machine language translation is inaccurate.

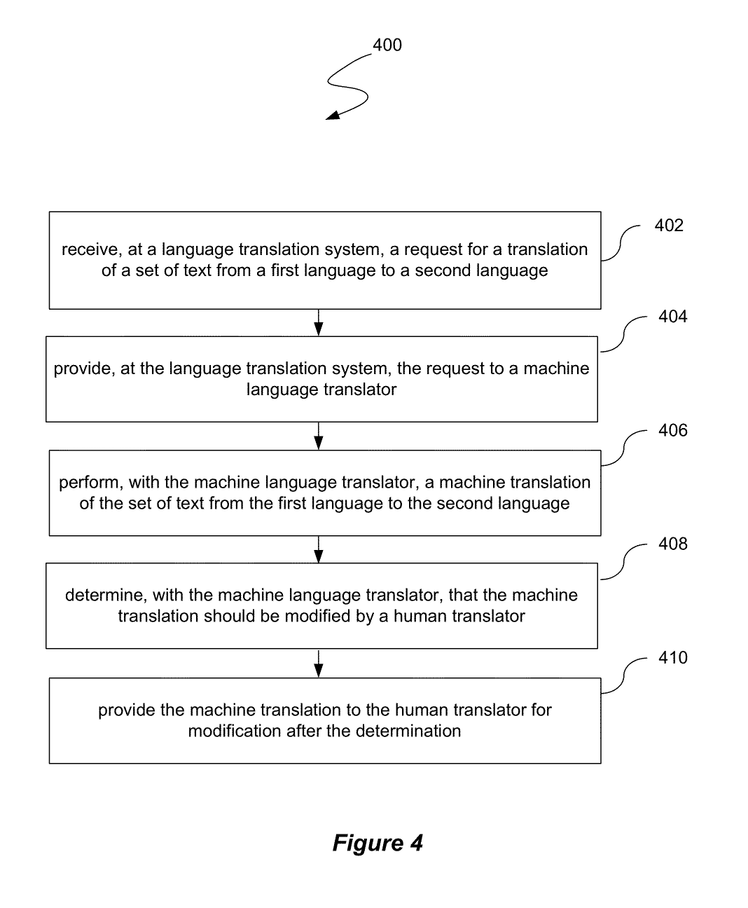

FIG. 4 illustrates a process 400 that provides a transition from a machine language translator to a human language translator. At a process block 402, the process 400 receives, at a language translation system, a request for a translation of a set of text from a first language to a second language. Further, at a process block 404, the process 400 provides, at the language translation system, the request to a machine language translator. In addition, at a process block 406, the process 400 performs, with the machine language translator, a machine translation of the set of text from the first language to the second language. At a process block 408, the process 400 also determines, with the machine language translator, that the machine translation should be modified by a human translator. Further, at a process block 410, the process 400 provides the machine translation to the human translator for modification after the determination.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of storing those instructions and include a CD-ROM, DVD, magnetic or other optical disc, tape, silicon memory, e.g., removable, non-removable, volatile or non-volatile, etc.

A computer is herein intended to include any device that has a general, multi-purpose or single purpose processor as described above. For example, a computer may be a set top box, cell phone, smart phone, tablet device, portable media player, video player, or the like.

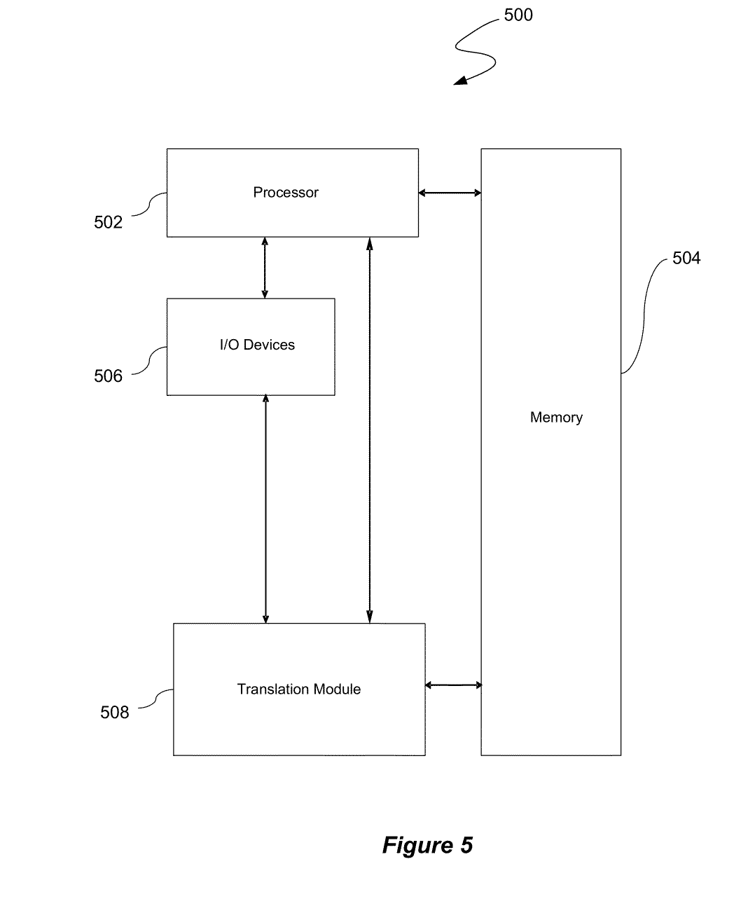

FIG. 5 illustrates a block diagram of a system 500 that provides routing from machine language translation to human language translation. In one embodiment, the system 500 is implemented utilizing a general purpose computer or any other hardware equivalents. Thus, the system 500 comprises a processor 502, a memory 504, e.g., random access memory (“RAM”) and/or read only memory (ROM), various input/output devices 506, (e.g., audio/video outputs and audio/video inputs, storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)), and a translation module 508.

It should be understood that the translation module 508 may be implemented as one or more physical devices that are coupled to the processor 502. Alternatively, the translation module 508 may be represented by one or more software applications (or even a combination of software and hardware, e.g., using application specific integrated circuits (ASIC)), where the software is loaded from a storage medium, (e.g., a magnetic or optical drive, diskette, or non-volatile memory) and operated by the processor 502 in the memory 504 of the computer. As such, the translation module 508 (including associated data structures) of the present disclosure may be stored on a computer readable medium, e.g., RAM memory, magnetic or optical drive or diskette and the like. The system 500 may be utilized for a hardware implementation of any of the configurations provided herein.

It is understood that the computer program products, apparatuses, systems, and processes described herein may also be applied in other types of apparatuses, systems, and processes. Those skilled in the art will appreciate that the various adaptations and modifications of the embodiments of the apparatuses, systems, and processes described herein may be configured without departing from the scope and spirit of the present computer program products, apparatuses, systems, and processes. Therefore, it is to be understood that, within the scope of the appended claims, the present computer program products, apparatuses, systems, and processes may be practiced other than as specifically described herein.

I claim:

1. A method comprising:
receiving, at a language translation system, a request for a translation of a set of text from a first language to a second language;
providing, at the language translation system, the request to a machine language translator;
performing, with the machine language translator, a machine translation of the set of text from the first language to the second language;
determining, with the machine language translator, that the machine translation should be modified by a human translator; and
providing the machine translation to the human translator for modification after the determination.

2. The method of claim 1, wherein the machine language translator performs the determination by analyzing the set of text for accuracy.

3. The method of claim 2, wherein the accuracy is determined by the machine language translator translating the machine translation from the second language to the first language to generate a subsequent machine translation and comparing the machine translation with the subsequent machine translation.

4. The method of claim 1, wherein the machine language translator performs the determination by analyzing at least one user input.

5. The method of claim 1, wherein the request for the translation requests a real-time response.

6. The method of claim 1, wherein the request for the translation requests a response with a time delay.

7. The method of claim 1, wherein the request is received from a computing device.

8. A computer program product comprising a computer readable medium having a computer readable program stored thereon, wherein the computer readable program when executed on a computer causes the computer to:
receive, at a language translation system, a request for a translation of a set of text from a first language to a second language;
provide, at the language translation system, the request to a machine language translator;
perform, with the machine language translator, a machine translation of the set of text from the first language to the second language;
determine, with the machine language translator, that the machine translation should be modified by a human translator; and
provide the machine translation to the human translator for modification after the determination.

9. The computer program product of claim of claim 8, wherein the machine language translator performs the determination by analyzing the set of text for accuracy.

10. The computer program product of claim 9, wherein the accuracy is determined by the machine language translator translating the machine translation from the second language to the first language to generate a subsequent machine translation and comparing the machine translation with the subsequent machine translation.

11. The computer program product of claim 8, wherein the machine language translator performs the determination by analyzing at least one user input.

12. The computer program product of claim 8, wherein the request for the translation requests a real-time response.

13. The computer program product of claim 8, wherein the request for the translation requests a response with a time delay.

14. The computer program product of claim 8, wherein the request is received from a computing device.

15. A system comprising:
a reception module that receives, at a language translation system, a request for a translation of a set of text from a first language to a second language;
a routing module that provides, at the language translation system, the request to a machine language translator;
a machine language translator that performs a machine translation of the set of text from the first language to the second language;
a processor that determines that the machine translation should be modified by a human translator; and
a modification module that provides the machine translation to the human translator for modification after the determination.

16. The system of claim 15, wherein the machine language translator performs the determination by analyzing the set of text for accuracy.

17. The system of claim 16, wherein the accuracy is determined by the machine language translator translating the machine translation from the second language to the first language to generate a subsequent machine translation and comparing the machine translation with the subsequent machine translation.

18. The system of claim 16, wherein the machine language translator performs the determination by analyzing at least one user input.

19. The system of claim 15, wherein the request for the translation requests a real-time response.

20. The system of claim 15, wherein the request for the translation requests a response with a time delay.
